(19) United States
(12) Patent Application Publication
(10) Pub. No.: US 2018/0260740 A1
(43) Pub. Date: Sep. 13, 2018

(54) SYSTEM AND METHOD TO OPTIMIZE A VEHICLE FLEET

(71) Applicant: GENERAL MOTORS LLC, Detroit, MI (US)

(72) Inventors: Pavan K. Namineni, Ann Arbor, MI (US); Donald K. Grimm, Utica, MI (US)

(73) Assignee: GENERAL MOTORS LLC, Detroit, MI (US)

(21) Appl. No.: 15/451,631

(22) Filed: Mar. 7, 2017

(51) Int. Cl. G06Q 10/02; G06Q 30/06

(52) U.S. Cl. CPC G06Q 10/02; G06Q 30/0645

(57) ABSTRACT

A system and method having a number of technological elements, one of which being a controller, which causes improvements to the controller and creates significantly more than the original default controller functionality. The elements collaborating to cause the controller to operate access at least one vehicle-share record; retrieve information from the vehicle-share record; receive vehicle system information from the vehicle; calculate a Return Time based, at least in part, on the vehicle system information received from the vehicle; compare the Return Time to the information retrieved from the vehicle-share record; modify vehicle-share record when the Return Time is greater than a value derived from the information retrieved from the vehicle-share record; and generate a notification when the Return Time is greater than the value derived from the information retrieved from the vehicle-share record.

### BACKGROUND

Vehicle sharing and self-serve vehicle rental services allow consumers to make reservations for station-based use of vehicles, particularly in urban environments. These rental vehicles are often located in reserved parking spots identified with permanently mounted signs or markers. To gain vehicle access, consumers select an available span of reservation time which is then stored into a digital calendar. A reservation buffer is additionally stored in this digital calendar for a time period subsequent to each reservation so as to ensure the vehicle does not get double-booked. However, these buffers decrease vehicle utilization there by allowing it to go unused for extended periods. Accordingly, it is desirable to provide a system and method for increasing vehicle utilization by reducing the necessary time duration these reservation buffers.

### SUMMARY

A system to optimize reservation times in a vehicle fleet is presented herein. The system includes: a memory, controller, and at least one vehicle. The memory is configured to include one or more executable instructions. The memory is further configured to include one or more vehicle-share records. The controller is configured to execute the executable instructions and communicate with the vehicle-share records. The vehicle(s) includes a vehicle system which is configured to generate information. The vehicle(s) is further configured to communicate with the controller. Moreover, the executable instructions enable the controller to: access at least one vehicle-share record; retrieve information from the vehicle-share record(s); receive vehicle system information from the vehicle(s); calculate an estimated Return Time based, at least in part, on the vehicle system information received from the vehicle(s); compare the Return Time to the information retrieved from the vehicle-share record(s); modify the vehicle-share record(s) when the Return Time is greater than a value derived from the information retrieved from the vehicle-share record(s); and generate a notification when the Return Time is greater than the value derived from the information retrieved from the vehicle-share record(s).

In certain instances, the system further includes a mobile computing device. The mobile computing device is configured to communicate with the controller. The mobile computing device itself also includes a display configured to exhibit information. Moreover, in these instances, the executable instructions further enable the controller to: send the generated notification to the mobile computing device in a format adapted to be exhibited on the display.

In certain instances, the system further includes a second vehicle configured to communicate with the controller. Moreover, in these instances, the modification to the vehicle-share record(s) is a vehicle reassignment. As such, the executable instructions further enable the controller to: designate the second vehicle as the reassigned vehicle in the vehicle-share record(s). Moreover, the generated notification includes vehicle reassignment information.

In certain instances, the system further includes a mobile computing device configured to communicate with the controller. In these instances, the mobile computing device includes a Global Positioning System (“GPS”) module configured to generate one or more GPS coordinates. Moreover, the vehicle system is defined as a GPS chipset configured to generate at least one location coordinate. As such, the executable instructions further enable the controller to: receive GPS coordinates from the mobile computing device; and receive location coordinates from the vehicle(s). Moreover, the Return Time calculation is based, at least in part, on the GPS coordinates in relation to the location coordinate(s).

In certain instances, the system further includes a second vehicle configured to communicate with the controller. In these instances, the modification to the vehicle-share record(s) is a vehicle reassignment. Moreover, the executable instructions further enable the controller to designate the second vehicle as the reassigned vehicle in the vehicle-share record(s).

In certain instances, the system further includes a second memory and second controller. In these instances, the memory and controller are considered to be a first memory and first controller. The second memory is configured to include a secondary set of executable instructions. The second memory is further configured to include an information database. The information database includes Consideration Data configured to be incorporated into the Return Time calculation. The second controller is configured to execute the secondary set of executable instructions. The second controller is further configured to communicate with the first controller. Moreover, the secondary set of executable instructions enable the second controller to: produce the Consideration Data from the information database; and send the Consideration Data to the first controller. In addition, the Return Time calculation is based, at least in part, on the vehicle system information received from the vehicle(s) in conjunction with the Consideration Data. The information database may be a traffic services database having traffic information of at least one location between the vehicle(s) and a designated location. The information database may be a weather services database having weather information of the location(s) between the vehicle(s) and a designated location.

In certain instances, the vehicle system is a GPS chipset configured to generate at least one location coordinate. The vehicle system information received from the vehicle(s) is the location coordinate(s). Moreover, in these instances, the executable instructions further enable the controller to: calculate an Estimated Vehicle Return based on the location coordinate and a designated coordinate; and wherein the Return Time calculation is based, at least in part, on the Estimated Vehicle Return.

In certain instances, the system further includes: a trip analytics module configured to produce a Return Prediction. In these instances, the vehicle system is defined as a GPS chipset configured to generate the location coordinate. Moreover, the vehicle system information received from the vehicle(s) is one or more location coordinates. As such, the executable instructions further enable the controller to: send the location coordinates to the trip analytics module; and retrieve a produced Return Prediction from the trip analytics module. Moreover, the Return Time calculation is based, at least in part, on the Return Prediction.

A method to optimize reservation times in a vehicle fleet is also presented herein. The method includes the steps of: providing a memory configured to include one or more executable instructions, the memory further configured to include one or more vehicle-share records; providing a controller configured to execute the executable instructions, the controller further configured to communicate with the vehicle-share records; providing at least one vehicle comprising a vehicle system configured to generate information, the vehicle configured to communicate with the controller; accessing (via the controller) at least one vehicle-share record; retrieving (via the controller) information from the vehicle-share record(s); receiving (via the controller) vehicle system information from the vehicle(s); calculating (via the controller) a Return Time based, at least in part, on the vehicle system information received from the at least one vehicle(s); comparing (via the controller) the Return Time to the information retrieved from the vehicle-share record(s); modifying (via the controller) the vehicle-share record(s) when the Return Time is greater than a value derived from the information retrieved from the vehicle-share record(s); and generating (via the controller) a notification when the Return Time is greater than the value derived from the information retrieved from the vehicle-share record(s).

The above features and advantages and other features and advantages of the present teachings are readily apparent from the following detailed description for carrying out the teachings when taken in connection with the accompanying drawings.

### DESCRIPTION OF THE DRAWINGS

The disclosed examples will hereinafter be described in conjunction with the following drawing figures, wherein like numerals denote like elements, and wherein:

FIG. 1 is a diagram illustrating an exemplary embodiment of a communication system according to an aspect of the system and method presented herein;

FIG. 2 is a schematic representation of an embodiment of a system to optimize a vehicle fleet in a vehicle-share system;

FIG. 3 is a tabular representation of an embodiment of a context database code segment which may be incorporated into the system of FIG. 2; and

FIG. 4 is an exemplary flow chart of an exemplary algorithmic method of a trip analytics module.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs or code segments, a combinational logic circuit, and/or other suitable components that provide the described functionality.

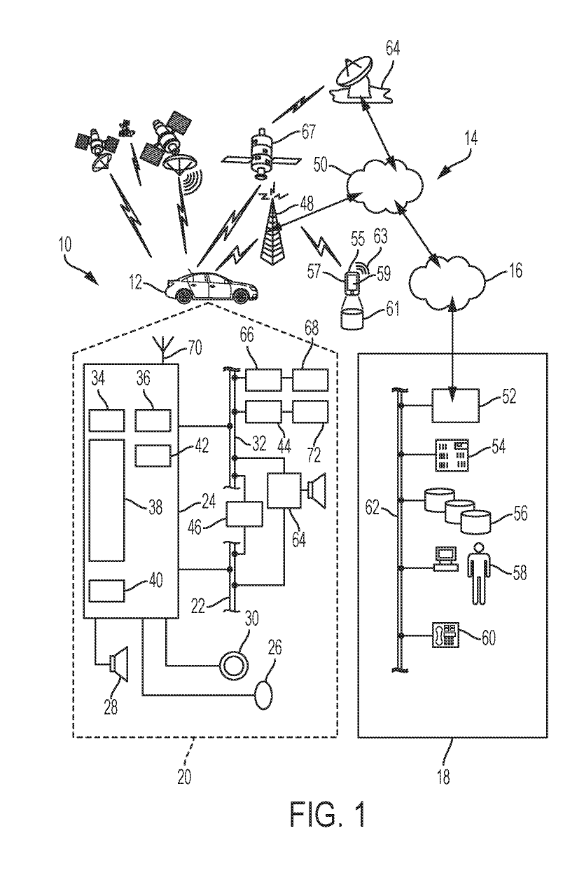

As shown in FIG. 1, there is shown a non-limiting example of a communication system 10 that may be used together with examples of the apparatus/system disclosed herein or to implement examples of the methods disclosed herein. Communication system 10 generally includes a vehicle 12, a wireless carrier system 14, a land network 16 and a call center 18. It should be appreciated that the overall architecture, setup and operation, as well as the individual components of the illustrated system are merely exemplary and that differently configured communication systems may also be utilized to implement the examples of the method disclosed herein. Thus, the following paragraphs, which provide a brief overview of the illustrated communication system 10, are not intended to be limiting.

Vehicle 12 may be any type of mobile vehicle such as a motorcycle, car, truck, recreational vehicle (RV), boat, plane, etc., and is equipped with suitable hardware and software that enables it to communicate over communication system 10. Some of the vehicle hardware 20 is shown generally in FIG. 1 including a telematics unit 24, a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides a variety of services through its communication with the call center 18, and generally includes an electronic processing device 38, one or more types of electronic memory 40, a cellular chipset/component 34, a wireless modem 36, a dual mode antenna 70, and a navigation unit containing a GPS chipset/component 42 capable of communicating location information via a GPS satellite system. GPS chipset/component 42 thus receives coordinate signals from a constellation 65 of GPS satellites. From these signals, the chipset 42 can determine vehicle position used for providing navigation and other position-related services to the vehicle operator. Navigation information can be presented on a display of telematics unit 24 (or other display within the vehicle), to VSM 42, or can be presented verbally such as is done when supplying turn-by-turn navigation. The navigation services can be provided using a dedicated in-vehicle navigation module (which can be part of GPS chipset/component 42), or some or all navigation services can be done via telematics unit 24, wherein the location coordinate information is sent to a remote location (mapping data module 107) for purposes of providing the vehicle with navigation maps, map annotations (points of interest (POI), etc.), route calculations, and the like. The position information can be supplied to data center 18 or other remote computer system, such as computer 18, for other purposes, such as fleet optimization and management.

The telematics unit 24 may provide various services including: turn-by-turn directions and other navigation-related services provided in conjunction with the GPS chipset/component 42; airbag deployment notification and other emergency or roadside assistance-related services provided in connection with various crash and/or collision sensor interface modules 66 and collision sensors 68 located throughout the vehicle; and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services telematics unit 24 may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and the wireless modem 36 for data transmission. Any suitable encoding or modulation technique may be used with the present examples, including digital transmission technologies, such as TDMA (time division multiple access), CDMA (code division multiple access), W-CDMA (wideband CDMA), FDMA (frequency division multiple access), OFDMA (orthogonal frequency division multiple access), etc. To accomplish this effect, dual mode antenna 70 services the GPS chipset/component 42 and the cellular chipset/component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware also includes one or more buttons and/or controls 30 for enabling a vehicle occupant to activate or engage one or more of the vehicle hardware components 20. For example, one of the buttons and/or controls 30 can be an electronic pushbutton used to initiate voice communication with call center 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to telematics unit 30 via the crash and/or collision detection sensor interface 66 regarding the severity of a vehicle collision, such as the angle of impact and the amount of force sustained.

Vehicle sensors 72, connected to various sensor interface modules 44 (VSMs) in the form of electronic hardware components located throughout vehicle 12 and use the sensed input to perform diagnostic, monitoring, control, reporting and/or other functions. Each of the VSMs 44 is preferably connected by vehicle bus 32 to the other VSMs, as well as to the telematics unit 24, and can be programmed to run vehicle system and subsystem diagnostic tests. As examples, one VSM 44 can be an engine control module (ECM) that controls various aspects of engine operation such as fuel ignition and ignition timing and another VSM 44 can be a powertrain control module that regulates operation of one or more components of the vehicle powertrain. According to one embodiment, the ECM is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. Another VSM 44 can be a body control module (BCM) that governs various electrical components located throughout the vehicle, like the vehicle's power door locks, engine ignition, and headlights.

A passive entry passive start (PEPS) module is another type of VSM 44 connected to the vehicle bus 32 and provides passive detection of the absence or presence of a passive physical key or a virtual vehicle key. When the passive physical key or smart phone 57 with virtual vehicle key approaches, the PEPS module 44 can determine if the passive physical key belongs to the vehicle 12 and/or (in some embodiments) determine if the virtual vehicle key is authorized/authentic. If the virtual vehicle key is authentic, the PEPS module 44 can send a command to the BCM permitting access to the vehicle 12—an example of which is disclosed in U.S. Patent Application Publication 2016/0203661 titled “VIRTUAL KEYFOB FOR VEHICLE SHARING”, the pertinent portions of which being herein incorporated by reference. Furthermore, as is appreciated by those skilled in the art, the above-mentioned VSMs are only examples of some of the modules that may be used in vehicle 12, as numerous others are also possible.

Wireless carrier system 14 may be a cellular telephone system or any other suitable wireless system that transmits signals between the vehicle hardware 20 and land network 16. According to an example, wireless carrier system 14 includes one or more cell towers 48.

Land network 16 can be a conventional land-based telecommunications network connected to one or more landline telephones, and that connects wireless carrier system 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

One of the networked devices that can directly or indirectly communicate with the telematics unit 24 is a mobile computing device 57, such as (but not limited to) a smart phone, personal laptop computer or tablet computer having two-way communication capabilities, a wearable computer such as (but not limited to) a smart watch or glasses, or any suitable combinations thereof. The mobile computing device 57 can include computer processing capability, a transceiver 53 capable of communicating with wireless carrier system 14, a digital camera 55, a visual display 59, and/or a GPS module 63 capable of receiving GPS satellite signals and generating GPS coordinates based on those signals. In some implementations, display 59 also includes an interactive touch-screen graphical user interface. Examples of the mobile computing device 57 include the iPhone™ and Apple Watch™ each being manufactured by Apple, Inc. and the Droid™ smart phone manufactured by Motorola, Inc. as well as others.

Mobile device 57 may be used inside or outside of a vehicle (such as the vehicle 12 shown in FIG. 1), and may be coupled to the vehicle by wire or wirelessly. The mobile device may also be configured to provide services according to a subscription agreement with a third-party facility or wireless/telephone service provider. It should be appreciated that various service providers may utilize the wireless carrier system 14 and that the service provider of telematics unit 30 may not necessarily be the same as the service provider of mobile device 57.

When using a short-range wireless connection (SRWC) protocol (e.g., Bluetooth Low Energy, Wi-Fi, etc.), mobile computing device 57 and telematics unit 24 may pair with each other (or link to one another) on a case-by-case basis when within a wireless range. This unique pairing may allow mobile computing device 57 to act as a virtual key fob to operate vehicle 12 through telematics unit 24. In order to pair in this manner, a set of unique encryption keys may be sent to both mobile computing device 57 and telematics unit 24. Call center 20 may moreover participate. For example, call center 20 may generate the encryption keys as well as a corresponding access token for both telematics unit 24 and mobile computing device 57—an example of which being disclosed in U.S. Patent Application Publication 2016/0203661, as discussed above as being properly incorporated herein.

Call center 18 is designed to provide the vehicle hardware 20 with a number of different system backend functions and, according to the example shown here, generally includes one or more switches 52, servers 54, databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58 or an automated response system, and data transmissions are passed on to a modem or other piece of telecommunication/computer equipment 60 for demodulation and further signal processing. The modem or other telecommunication/computer equipment 60 may include an encoder, as previously explained, and can be connected to various devices such as a server 54 and database 56.

Database 56 could be designed to store a backend aspect of a vehicle reservation account (explained in detail below) with numerous vehicle-share services records (i.e., vehicle reservation information) having information such as, but not limited to, vehicle-share services reservation account records (e.g., account demographic information), vehicle-share vehicle records (e.g., vehicle VSM information), reservation profile records (e.g., a reservation calendar including defined reservation start and end times, vehicle assignment information, parking spot location information, etc.), renter behavioral pattern records (POI information, time spent at the POI, day of the week attending the POI, etc.), subscription demographics (location of rental, group belongings, etc.), or any other pertinent vehicle-share reservation services information. This stored backend information could moreover be written in SQL (structured query language). In certain instances, this vehicle-share services records information may be copied, organized, and stored in a tabular form (spreadsheet) to be updated in real time and on an ongoing basis. The vehicle-share services records information can likewise be generated through a trip analytics module, so as to support the calculation of a Return Prediction as discussed below. The vehicle-share records can additionally collaborate with a vehicle-share services reservation account for purposes such as, but not limited to, reservation management, fleet management, and fleet optimization also as discussed below. Certain vehicle-share records (e.g., vehicle records, reservation profile records) may also be associated with a particular vehicle in the fleet, certain records may be associated with the reservation account (e.g., the account records, renter behavioral pattern records, etc.), and certain vehicle-share records may be held in database 56 for more generalized purposes (e.g., subscription demographics).

The user of mobile computing device 57 may create their own personalized reservation account to be stored in mobile memory 61 and which may have access to the vehicle-share records. The user may perform tasks to create this account through a variety of frontend devices such as through a remote computer and mobile computing device 57 or through live advisor 86 at call center 20. The user account may be accessible on server 82 (i.e., to support backend functions). Call center 20 may also access one or more additional remote servers and/or remote databases (e.g., Department of Motor Vehicles or Localized Police databases) to receive information in support of the reservation account.

The reservation account may include validating data to verify and/or validate that future login attempts are secure (e.g., granting access only to the user). The validating data may include an account username and account password as well as user information (e.g., driver's license number), mobile computing device information such as, for example, the unique mobile device identifier (i.e., serial number). The user account may additionally store a variety of user preferences.

The user of the mobile device 57 may visit an online software application store or web-service and download the reservation account therefrom. The reservation account may moreover include one or more graphical user interfaces (GUIs) to be exhibited through display 59, and which include one or more prompts to instruct the user to provide information (e.g., validating data) to support user account creation. Reservation account may be configured to assist a vehicle-share system user (mobile computing device user) in reserving vehicle 12 by operatively accessing and communicating with the backend vehicle-share services records.

Although the illustrated example has been described as it would be used in conjunction with a call center 18 that is manned, it will be appreciated that the call center 18 can be any central or remote facility, manned or unmanned, mobile or fixed, to or from which it is desirable to exchange voice and data.

### Vehicle Fleet Optimization System

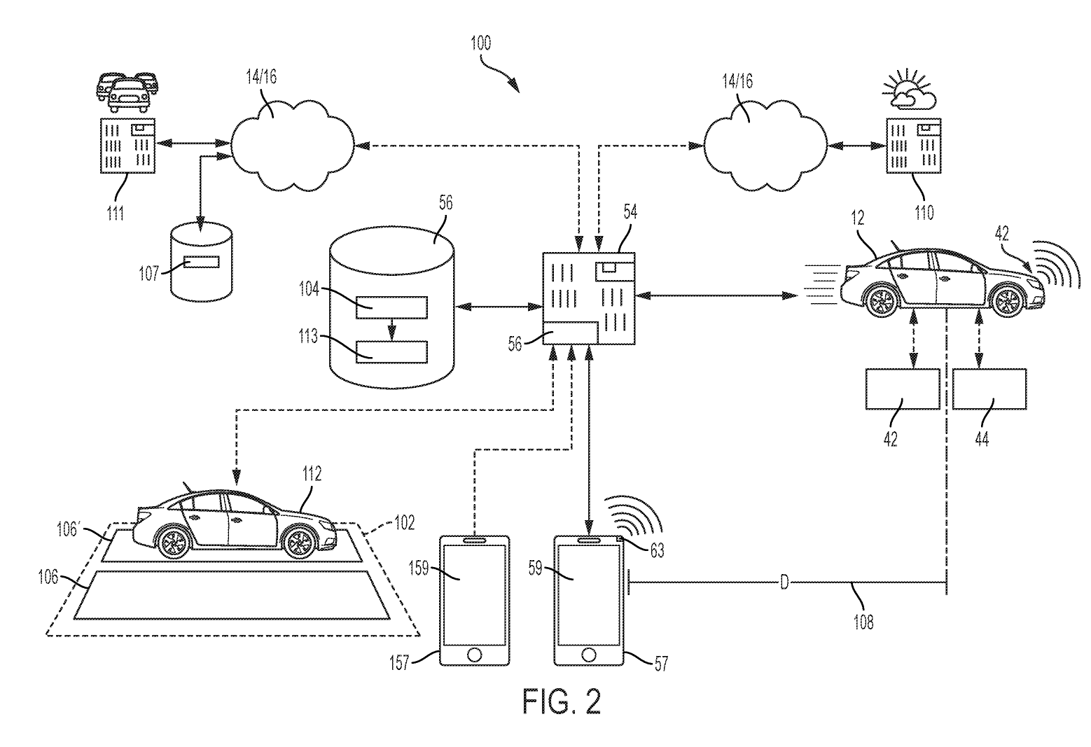

FIG. 2 shows an exemplary schematic representation of a system to optimize vehicle reservation times in a fleet 100 of a vehicle-share system. System 100 may be performed to estimate a vehicle return time (otherwise known as “Return Time”) based on vehicle and/or customer location contexts, and which may be used to generate user and vehicle notifications as well as reorganize vehicle assignments. As can be seen, system 100 is supported by communication system 10 and each system implements common features.

In one embodiment of system 100, a user may use their reservation account to request the reservation of a vehicle 12 from a selected vehicle location 102. This reservation information is then sent to one or more of the vehicle-share records for updates thereto. At the backend, server 54 will then collaborate with database 56 and one or more of the vehicle-share services records 104 (e.g., reservation profile records) to determine a subset of the fleet available during the requested reservation window of operation. For example, server 54 can manage the use of a fleet of ten (10) vehicles at a selected vehicle location 102 and determine that four (4) of those vehicles will be available during the requested reservation times. Server 54 will then select one of those vehicles 12 using a vehicle identifier and assign that identifier to the reservation account, corresponding vehicle share records, and user for use during the requested reservation window of operation. As vehicles are requested and used, the server 54 can determine the identities of the vehicles currently in use (and therefore unavailable) and monitor upcoming reservation windows of operation associated with vehicles in the fleet to understand which vehicles are available at any particular time. This monitoring may thus be conducted through review of one or more vehicle share records.

During a particular window of operation, server 54 can collaborate with one or more vehicle-share records 104, mobile computing device 57, and/or the vehicle 12 to calculate an approximated vehicle return time; in essence, a prediction as to when vehicle 12 will be returned to predesignated parking spot 106. This return time determines if the vehicle will be returned past the reservation's conclusion, and thus negatively affect any subsequent windows of operation assigned to that particular vehicle 12. It should be understood that server 54 may calculate the vehicle return time at any time prior to the conclusion of the reservation's window of operation. For instance, server 54 may periodically calculate the Return Time (e.g., every 15/30 minutes) after the start of the reservation or the Return Time may be calculated at some event during the reservation (e.g., when the engine is powered off).

To calculate this Return Time, server 54 will access the reservation profile records for vehicle 12 to retrieve and establish the Defined End Time from the original reservation details information. For example, the Defined End Time may be established as 2:00 PM.

Server 54 will subsequently communicate with GPS chipset/component 42 to receive a location coordinate and determine the vehicle position therefrom. Server 54 will also put this location coordinate in relation to parking spot 106 (i.e., a designated coordinate). Based on these locations, server 54 will then estimate a time in which vehicle 12 should return to parking spot 106 (“Estimated Vehicle Return”). For example, based on these location coordinates in conjunction with mapping data module 107, the given coordinate sets may be provided on a digitally formatted logical model of a real-world map. From there, server 54 may calculate that vehicle 12 is approximately four miles from parking spot 106. Further based on one or more route calculation application program interfaces (“routing APIs”) in communication with the mapping data module, server 54 may estimate that it will take vehicle 12 twenty (20) minutes to arrive at parking location 106. It should be understood that the mapping data module 107 and routing APIs may be defined as one or more generally known cloud-based interfaces (for example—a routing engine such as, but not limited to, GRAPHHOPPER™). Furthermore, mapping data module 107 may communicate with an API that acts as a support service to provide POI information within the digital map (for example, but not limited to, the GOOGLE™ Places API).

When both the Defined End Time and Estimated Vehicle Return are established, server 54 will calculate the Return Time for vehicle 12. The equation to calculate this Return Time is as follows:

RT=C_{T}+T_{V}

where RT is the calculated Return Time, C_{T} is the Current Time and T_{V} is the Estimated Vehicle Return. Therefore, for example, if C_{T} is found to be 1:45 PM and T_{V} is found to be twenty (20) minutes, then RT equals 2:05 PM.

Server 54 then compares the calculated Return Time with the Defined End Time to see which holds the greater value. In this example, as discussed above, the Return Time equals 2:05 PM and the Defined End Time equals 2:00 PM. Thus, the Return Time>the Defined End Time. In other words, the return time will be five (5) minutes after the Defined End Time of the original reservation information (five minutes late).

Furthermore, in those instances RT is calculated to be before the Defined End Time, server 54 may allow the current reservation window of operation to conclude as established by the original reservation. However, in those instances that RT is calculated to be after the reservation end time, server 54 will access certain vehicle-share records (e.g., reservation profile records) and modify the reservation information associated with the subsequent window of operation. Consequently, for example, server 54 will create a vehicle reassignment for this reservation. This reassignment designates another subset of the fleet, a secondary vehicle 112, (available during the requested reservation window of operation) as the assigned vehicle of the subsequent reservation. In certain instances, the backup vehicle 112 may or may not be of an equivalent model to vehicle 12 or it may be a model considered superior to that of vehicle 12. In another example, server 54 may generate late-fee information. This late fee will be included in the final charge provided to the user via the reservation account upon the conclusion of the reservation and may be conducted through generally known vehicle-share system processes.

Server 54 may generate a notification (e.g., text message) and send that notification of the vehicle reassignment/late-fee information in a format which can be displayed on a mobile computing device 157 associated with the subsequent reservation. Server 54 may also generate and send a notification of the vehicle reassignment to be displayed through mobile computing device 57 and/or the telematics unit 24 of vehicle 12. These notifications may additionally be used to notify the system user(s) that vehicle 12 is unlikely to be returned to parking spot 102 on time.

Server 54 may additionally communicate with one or more vehicle sensor modules 44 (e.g., the ECM) and/or the collision detection sensor 66 to determine if an Unexpected Delay Event might have occurred (e.g, vehicle collision, engine malfunction, engine being powered down, etc.). Server 54 will then use the Unexpected Delay Event to estimate a time in which vehicle 12 should return to parking spot 106. For example, based on an Unexpected Delay Event associated with a vehicle collision, it may be estimated that it will take vehicle 12 an additional thirty (30) to arrive at parking spot 106. Furthermore, one or more databases of delay information may be used to support a properly estimated time for the Unexpected Delay Event. Skilled artisans will understand that databases of delay information are generally known.

When the Unexpected Delay Event is established, server 54 will calculate the Return Time for vehicle 12. The equation to calculate the Return Time in this embodiment of system 100 is as follows:

RT=C_{T}+T_{V}+T_{O}

where T_{O} is the Estimated Unexpected Delay Event (the other variables being discussed above). Therefore, for example, if C_{T} is found to be 1:45 PM and T_{V} is calculated to be twenty (20) minutes and T_{O} is calculated to be thirty (30) minutes, then RT equals 2:35 PM.

As discussed above, server 54 then compares the calculated Return Time with the Defined End Time to see which holds the greater value. In this example, the Return Time equals 2:35 PM and the Defined End Time equals 2:00 PM. Thus, the Return Time>the Defined End Time. In other words, the return time will be thirty five (35) minutes late.

Since RT is calculated to be after the Defined End Time, server 54 will access certain vehicle-share records (e.g., reservation profile records) and modify the reservation information associated with the subsequent window of operation. In turn, server 54 will change the vehicle assignment for this reservation—to the available backup vehicle 112. Server 54 will also generate a notification of the vehicle reassignment and may send that notification to second user's mobile computing device 157 (associated with the subsequent window of operation). Server 54 may also generate and send a notification of the reassignment to be displayed through the telematics unit 24 of vehicle 12. These notifications may additionally be used to notify the system user(s) that vehicle 12 is unlikely to be returned to parking spot 102 before the reservation expires.

In one or more other embodiments, server 54 may further communicate with GPS module 63 to additionally determine the GPS coordinates of the user's mobile computing device 57 as well as its distance 108 in relation to vehicle 12. Based on distance 108, server 54 will then estimate a time in which the mobile computing device 57 (i.e., system user) should return to vehicle 12 (“Estimated User Return”). For example, based on the communicated GPS coordinates of both vehicle 12 and mobile computing device 57 in conjunction with a mapping data module 107, it may be determined that mobile computing device 57 is 0.12 miles from vehicle 12. Based on this information, it may be further estimated that it will take mobile computing device 57 twelve (12) minutes to arrive at vehicle 12. Furthermore, heading information and breadcrumb trace data may be captured by the mapping data module 107 to support a properly calculated time for the Estimated User Return. Skilled artisans will understand that capturing heading information and breadcrumb trace data is generally known.

When the Estimated User Return is established, server 54 will calculate the Return Time for vehicle 12. The equation to calculate the Return Time in this embodiment of system 100 is as follows:

RT=C_{T}±T_{V}+T_{M}

where T_{M} is the Estimated Mobile Device Return (the other variables being discussed above). Therefore, for example, if C_{T} is found to be 1:45 PM and T_{V} is calculated to be twenty (20) minutes and T_{M} is calculated to be twelve (12) minutes, then RT equals 2:17 PM.

As discussed above, server 54 then compares the calculated Return Time with the Defined End Time to see which holds the greater value. In this example, the Return Time equals 2:17 PM and the Defined End Time equals 2:00 PM. Thus, the Return Time>the Defined End Time. In other words, the return time will be seventeen (17) minutes late.

Since RT is calculated to be after the reservation end time, server 54 will access certain vehicle-share records (e.g., reservation profile records) and modify the reservation information associated with the subsequent reservation window. In turn, server 54 will change the vehicle assignment for this reservation—to the available backup vehicle 112. Server 54 may also generate a notification of the vehicle reassignment and send that notification to mobile computing device 157 (associated with the subsequent reservation). Server 54 may also generate and send a notification of the reassignment to be displayed through the telematics unit 24 of vehicle 12. These notifications may additionally be used to notify the system user(s) that vehicle 12 is unlikely to be returned to parking spot 102 before the reservation expires.

In other embodiments, server 54 may further communicate with certain remote information servers 110, 111 having information databases that store pertinent Consideration Data. Such information may then be used to support a finding of a more accurate Return Time. For instance, weather services server 110 may provide weather delay related Consideration Data. This type of Consideration Data can add a time delay caused by weather relative to the areas falling between vehicle's GPS coordinates and parking spot 106. For example, it may be estimated that the average vehicle 12 would require an additional six (6) minutes to arrive at parking spot 106 due to inclement weather. Accordingly, when weather delay related Consideration Data has been incorporated, server 54 will calculate the Return Time through the equation as follows:

RT=C_{T}±T_{V}+T_{W}

where T_{W} is the Estimated Weather Delay (the other variables being discussed above). Therefore, for example, if C_{T} is found to be 1:45 PM and T_{V} is calculated to be twenty (20) minutes and T_{W} is calculated to be six (6) minutes, then RT equals 2:11 PM.

As discussed above, server 54 then compares the calculated Return Time with the Defined End Time to see which has the greater value. In this example, the Return Time equals 2:11 PM and the Defined End Time equals 2:00 PM. Thus, the Return Time>the Defined End Time. In other words, the return time will be eleven (11) minutes late.

In another instance, traffic services server 111 may provide traffic related Consideration Data. This type of Consideration Data can add time delays which are caused by traffic slowdowns in relation to the areas between vehicle's GPS coordinates and parking spot 106. For example, it may be estimated that vehicle 12 would need an additional eight (8) minutes to arrive at parking spot 106 due to traffic jams. As a result, when traffic delay related Consideration Data is incorporated, server 54 will calculate the Return Time through the equation as follows:

RT=C_{T}±T_{V}+T_{T}

where T_{T} is the Estimated Traffic Delay (the other variables being discussed above). Therefore, for example, if C_{T} is found to be 1:45 PM and T_{V} is calculated to be twenty (20) minutes and T_{T} is calculated to be eight (8) minutes, then RT equals 2:13 PM.

As discussed above, server 54 then compares the calculated Return Time with the Defined End Time to see which has the greater value. In this example, the Return Time equals 2:13 PM and the Defined End Time equals 2:00 PM. Thus, the Return Time>the Defined End Time. In other words, the return time will be thirteen (13) minutes late.

Since RT is calculated to be after the reservation end time, server 54 will access certain vehicle-share records (e.g., reservation profile records) and modify the reservation information associated with the subsequent reservation window of operation. In turn, server 54 will change the vehicle assignment for this reservation—to available backup vehicle 112. Server 54 may also generate a notification of the vehicle reassignment and send that notification to mobile computing device 157 (associated with the subsequent reservation). Server 54 may also generate and send a notification of the reassignment to be displayed through the telematics unit 24 of vehicle 12. These notifications may additionally be used to notify the system user(s) that vehicle 12 is unlikely to be returned to parking spot 102 before the reservation expires.

In one or more embodiments, server 54 may further communicate with a trip analytics module 113 to produce a Return Prediction derived from previously visited POIs (e.g., restaurants, grocery stores, movie theaters, malls, sporting events, etc.) to estimate an additional delay for the return of vehicle 12. Server 54 will use the Return Prediction to support an estimated time in which vehicle 12 should return to parking spot 106.

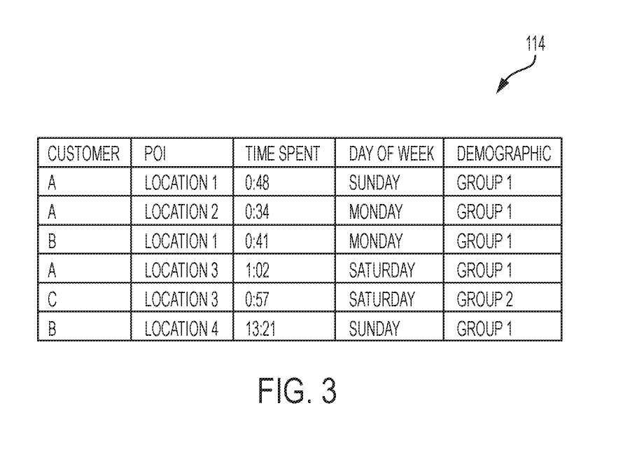

With additional reference to FIG. 3, trips analytics module 113 incorporates a context database 114 within its algorithmic processes 200 to generate the Return Prediction. As shown, an embodiment of context database 114 includes data organized in tabular form and broken down at different levels: POI, Time Spent, Day of Week, and demographic information (e.g., group associations). The POI column is moreover characterized by the duration of time spent at each location. This data is generally collected and included in the location coordinates provided by GPS chipset/component 42. Skilled artisans will understand that this portions of information may be gathered into context database 114 from the rental operations for each subset of the vehicle fleet or a population of vehicles from multiple vehicle fleets being at different locations 102.

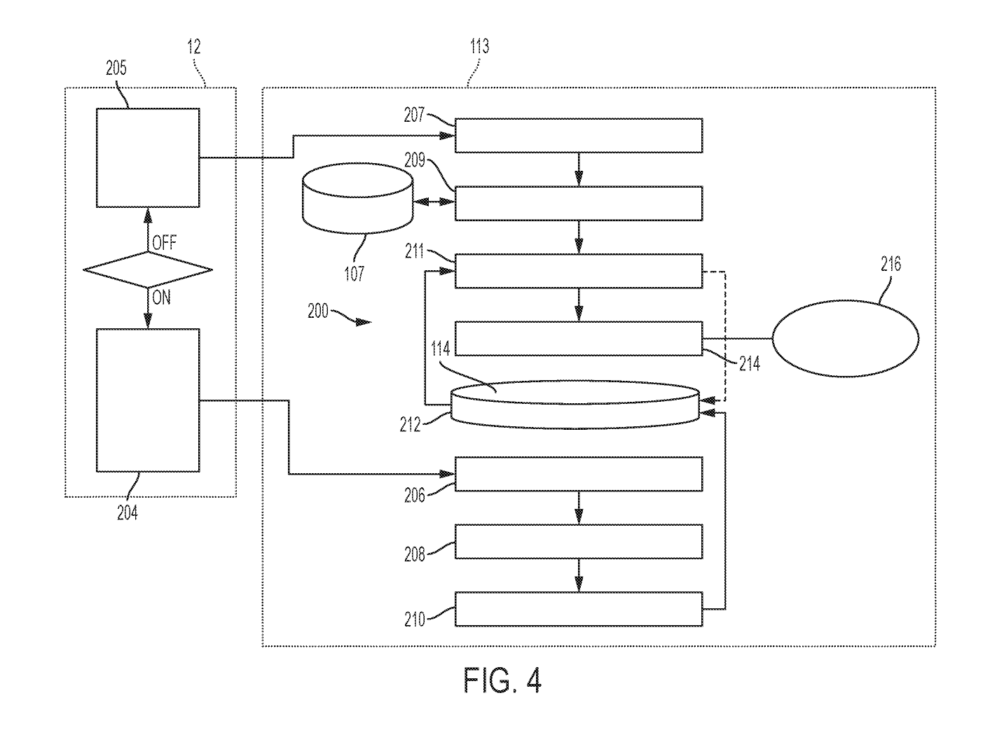

With even further reference to FIG. 4, an exemplary flow chart of an algorithmic method of trip analytics module 113 has been depicted. One or more steps of method 200 may be executed through the implementation of server 54 which may include one or more executable instructions incorporated into memory 56. Method 200 is moreover supported by receiving one or more location coordinates from vehicle 12. These location coordinates may either be an On State Receiver Handler (i.e., when the vehicle ignition is powered on) or an Off State Receiver Handler (i.e., when the vehicle ignition is unpowered) and could be embodied in an .xml or .json data format. In addition, when the location coordinates are received as an On State Receiver Handler, shown in step 204, the map-matched location of vehicle 12 is provided to analytics module 113. A generally known and non-limiting example of an On State Receiver Handler is shown as follows:

<ign_state=ON><utc_ time=000000000><map_lat=42.5372634><map_lon=−83.293848>or
<ign_state=ON><utc_ time=000000000><place_name=″Best Buy″><Address1=12345 Van
Dyke><City=Warren>

When the location coordinates are received as an Off State Receiver Handler, shown in step 205, heading information, the GPS coordinates, stamped-time-duration information, and the last known latitude and longitude positions as well as a list of previously known latitude and longitude positions are provided to analytics module 113. A generally known and non-limiting example of an Off State Receiver Handler is shown as follows:

<ign_state=OFF><utc_time=000000000><lat=42.5372634><lon=−83.293848>
<heading=181.2><lat−0=42.5372877><lon-0=−83.3847575> ...<lat-n=...>

The On State Receiver Handler and Off State Receiver Handler each also proceed through an independent path within the disclosed embodiment of Method 200 before reaching step 214, the step of which the paths are to join.

Focusing on the aspect of Method 200 where location coordinates are an On State Receiver Handler, the map-matched data is received by analytics module 113 at step 206. The time data provided in the Handler is then reviewed, analyzed, and the total time spent at the location coordinate is subsequently calculated (see FIG. 3), at step 208. This calculated time is then aggregated with other calculated time durations at that particular location found in context database 114 (i.e., averaged into all the calculated time durations), at step 210. It should be understood that the average could be over all relevant data samples in database 114 or could be a rolling average of certain data samples (e.g., the most recent fifty (50) samples). The newly aggregated time duration is then populated back into context database 114, at step 212. The method then proceeds to step 211, which is discussed further below, and joins with the Off State Receiver Handler methodology pathway.

Focusing on the aspect of Method 200 where location coordinates are an Off State Receiver Handler—the heading, GPS coordinates, stamped time duration information, and all known latitude and longitude position data is received by analytics module 113, at step 207. Analytics module 113 then communicates with mapping data module 107 to provide a corresponding map-matched version of the location coordinates to be associated with the stamped time duration information, at step 209. The method then proceeds to step 211 and joins with the Off State Receiver Handler methodology pathway.

At step 211, analytics module 113 reviews and analyzes the time duration information from either step 209 or 212. For example, when an On State Receiver Handler is received, analytics module 113 will review and analyze the aggregated time duration for each visited POI found in context database 114. In another example, when an Off State Receiver Handler is received, analytics module 113 will review and analyze the stamped time duration for each map-matched POI found in context database 114. These reviewed time durations are then added together and produced as the Return Prediction, in step 216. Furthermore, when an On State Receiver Handler is received, database 114 may optionally be updated with the map-matched versions of the latitude and longitude position data and GPS coordinates. Other embodiments of method 200 may include performing map matching at the vehicle 12 (sending map-matched coordinates for ignition powered on and unpowered), or having analytics module 113 continuously performing map matching (i.e., providing GPS coordinates data for ignition powered on and unpowered).

When the Return Prediction is produced, server 54 will calculate the Return Time for vehicle 12. The equation to calculate the Return Time in this embodiment of system 100 is as follows:

RT=C_{T}±T_{V}+T_{RP}

where T_{RP} is the time for the Return Prediction (the other variables being discussed above). Therefore, for example, if C_{T} is found to be 1:40 PM and T_{V} is calculated to be fifteen (15) minutes and T_{RP} is calculated to be six (6) minutes, then RT equals 2:01 PM (e.g., an additional delay taking into account—0:48 minutes at restaurant, 1:12 minutes at grocery store, 2:00 minutes at movie theaters, 0:30 minutes at mall, and 1:30 minutes at sporting event).

As discussed above, server 54 then compares the calculated Return Time with the Defined End Time to see which holds the greater value. In this example, the Return Time equals 2:01 PM and the Defined End Time equals 2:00 PM. Thus, the Return Time>the Defined End Time. In other words, the return time will be one (1) minute late.

Since RT is calculated to be after the Defined End Time, as discussed above, server 54 will access certain vehicle-share records (e.g., reservation profile records) and modify the reservation information associated with the subsequent reservation. In turn, server 54 will change the vehicle assignment for this reservation—to the available backup vehicle 112. Server 54 will also generate a notification of the vehicle reassignment and may send that notification to mobile computing device 157 (associated with the subsequent reservation). Server 54 may also generate and send a notification of the reassignment to be di splayed through the telematics unit 24 of vehicle 12. These notifications may additionally be used to notify the system user(s) that vehicle 12 is unlikely to be returned to parking spot 102 before the reservation expires.

In one or more other embodiments, the equation to calculate the Return Time may include multiple previously discussed variables in any number of combinations. RT for an embodiment of system 100 including all variables would be as follows:

RT=C_{T}+T_{V}+T_{O}+T_{M}+T_{W}+T_{T}+T_{RP}

each variable being discussed above. However, RT for other embodiments of system 100 may include an equation having more or less variables and in different combinations or arrangements. It should also be understood that embodiments of system 100 may determine that the Reservation Time being equal to the Defined End Time will permit server 54 to access certain vehicle-share records (e.g., reservation profile records) and modify the reservation information associated with the subsequent operation.

### Method

An exemplary embodiment of a method to optimize vehicle reservation times in the fleet of a vehicle-share system is below discussed. One or more steps of this method may be completed through the implementation of server 54 executing instructions/code segments (software algorithms) incorporated into database 56. It should be understood that the steps of this method are not necessarily required to be carried out in the order presented below.

In a first step, server 54 will access at least one of the vehicle-share records (e reservation profile records) in database 56. Subsequently, in a second step, server 54 will retrieve certain information (e.g., the Defined End Time) from the accessed vehicle-share records. In this step, server 54 will further access the information retrieval time (i.e., the Current Time) from an internal clock program which may be incorporated into database 56.

The server 54 will then retrieve vehicle system information from vehicle 12, in a third step. In one embodiment, the vehicle system information is one or more location coordinates from GPS chipset/component 42. Consequently, in this third step, server 54 will determine the vehicle position from the location coordinates as well as calculate an Estimated Vehicle Return time (discussed above). In a fourth step, server 54 will calculate a Return Time based, at least in part, on the vehicle system information (e.g., using the derived Estimated Vehicle Return (T_{V}) from the location coordinates as a variable) (discussed above). In a fifth step, server 54 will compare the Return Time to the Defined End Time to see which holds the greater value (discussed above). The server 54 will then modify the vehicle-share record only when the Return Time holds a greater value than (or, in some embodiments, equal thereto) the value held by the Defined End Time (i.e., when the Return Time is after the Defined End Time). The modification to the vehicle-share record may be a vehicle reassignment created for the records associated with the subsequent reservation (discussed above). In another embodiment, server 54 may generate late-fee information and store such information into the vehicle-share records (discussed above). Moreover, in those instances when the Return Time holds the greater value, in a sixth step, server 54 will generate a notification. As discussed above, this notification is related to the embodied record modification (of the fifth step) and may be sent either the first or second mobile computing device 57, 157 or telematics unit 24.

In an optional set of steps, in a first optional step, a remote information server 110, 111 produces Consideration Data from an information database. In one embodiment this remote server is a weather services server 110 and in another embodiment it is a traffic services server 111. In a second optional step, the remote information server 110, 111 sends the Consideration Data to server 54 to become a variable factored into the Return Time (discussed above).

In another optional set of steps, in a first optional step, server 54 will send the location coordinates to a trip analytics module (as discussed above). In a second optional step, the trip analytics module will produce a Return Prediction through its algorithmic method (discussed above). In a third optional step, server 54 will calculate a Return Time that has the Return Prediction as a variable within its equation (discussed above).

While various exemplary embodiments have been presented in the foregoing detailed description, it should be appreciated that a vast number of variations exist. It should also be appreciated that the exemplary embodiments are only examples, and are not intended to limit the scope, applicability, or configuration of the disclosure in any way. Rather, the foregoing detailed description will provide those skilled in the art with a convenient road map for implementing the exemplary embodiments. It should be understood that various changes can be made in the function and arrangement of elements without departing from the scope of the disclosure as set forth in the appended claims and the legal equivalents thereof.

1. A system to optimize reservation times in a vehicle fleet, the system comprising:
a memory configured to comprise one or more executable instructions, the memory further configured to comprise one or more vehicle-share records;
a controller configured to execute the executable instructions, the controller further configured to communicate with the vehicle-share records;
at least one vehicle comprising a vehicle system configured to generate information, the vehicle configured to communicate with the controller;
wherein the executable instructions enable the controller to:
access at least one vehicle-share record;
retrieve information from the at least one vehicle-share record;
receive vehicle system information from the at least one vehicle;
calculate a Return Time based, at least in part, on the vehicle system information received from the at least one vehicle;
compare the Return Time to the information retrieved from the at least one vehicle-share record;
modify the at least one vehicle-share record when the Return Time is greater than a value derived from the information retrieved from the at least one vehicle-share record; and
generate a notification when the Return Time is greater than the value derived from the information retrieved from the at least one vehicle-share record.

2. The system of claim 1, further comprising:
a mobile computing device configured to communicate with the controller, the mobile computing device comprising a display configured to exhibit information; and
wherein the executable instructions further enable the controller to:
send the generated notification to the mobile computing device in a format adapted to be exhibited on the display.

3. The system of claim 2, further comprising:
a second vehicle configured to communicate with the controller;
wherein the modification to the at least one vehicle-share record is a vehicle reassignment; and
wherein the executable instructions further enable the controller to:
designate the second vehicle as the reassigned vehicle in the at least one vehicle-share record; and
wherein the generated notification comprises vehicle reassignment information.

4. The system of claim 1, further comprising:
a mobile computing device configured to communicate with the controller, the mobile computing device comprising a GPS module configured to generate one or more GPS coordinates;
wherein the vehicle system is a GPS chipset configured to generate at least one location coordinate;
wherein the executable instructions further enable the controller to:
receive GPS coordinates from the mobile computing device; and
receive location coordinates from the vehicle; and
wherein the Return Time calculation is based, at least in part, on the GPS coordinates in relation to the at least one location coordinate.

5. The system of claim 1, further comprising:
a second vehicle configured to communicate with the controller;
wherein the modification to the at least one vehicle-share record is a vehicle reassignment; and
wherein the executable instructions further enable the controller to:
designate the second vehicle as the reassigned vehicle in the at least one vehicle-share record.

6. The system of claim 1, further comprising:
wherein the memory and controller are considered a first memory and first controller;
a second memory configured to comprise a secondary set of executable instructions, the second memory further configured to comprise an information database; the information database comprising Consideration Data configured to be incorporated into the Return Time calculation;
a second controller configured to execute the secondary set of executable instructions, the second controller further configured to communicate with the first controller;
wherein the secondary set of executable instructions enable the second controller to:
produce the Consideration Data from the information database; and
send the Consideration Data to the first controller; and
wherein the Return Time calculation is based, at least in part, on the vehicle system information received from the at least one vehicle in conjunction with the Consideration Data.

7. The system of claim 6, wherein the information database is a traffic services database comprising traffic information of at least one location between the vehicle and a designated location.

8. The system of claim 6, wherein the information database is a weather services database comprising weather information of at least one location between the vehicle and a designated location.

9. The system of claim 1, wherein:
wherein the vehicle system is a GPS chipset configured to generate at least one location coordinate;
wherein the vehicle system information received from the vehicle is the at least one location coordinate;
wherein the executable instructions further enable the controller to:
calculate an Estimated Vehicle Return based on the at least one location coordinate and a designated coordinate; and
wherein the Return Time calculation is based, at least in part, on the Estimated Vehicle Return.

10. The system of claim 1, further comprising:
a trip analytics module configured to produce a Return Prediction;
wherein the vehicle system is a GPS chipset configured to generate at least one location coordinate;
wherein the vehicle system information received from the vehicle is one or more location coordinates;
wherein the executable instructions further enable the controller to:
send the location coordinates to the trip analytics module; and
retrieve a produced Return Prediction from the trip analytics module; and
wherein the Return Time calculation is based, at least in part, on the Return Prediction.

11. A method to optimize reservation times in a vehicle fleet, the method comprising:
providing a memory configured to comprise one or more executable instructions, the memory further configured to comprise one or more vehicle-share records;
providing a controller configured to execute the executable instructions, the controller further configured to communicate with the vehicle-share records;
providing at least one vehicle comprising a vehicle system configured to generate information, the vehicle configured to communicate with the controller;
accessing, via the controller, at least one vehicle-share record;
retrieving, via the controller, information from the at least one vehicle-share record;
receiving, via the controller, vehicle system information from the at least one vehicle;
calculating, via the controller, a Return Time based, at least in part, on the vehicle system information received from the at least one vehicle;
comparing, via the controller, the Return Time to the information retrieved from the at least one vehicle-share record;
modifying, via the controller, the at least one vehicle-share record when the Return Time is greater than a value derived from the information retrieved from the at least one vehicle-share record; and
generating, via the controller, a notification when the Return Time is greater than the value derived from the information retrieved from the at least one vehicle-share record.

12. The method of claim 11, further comprising:
providing a mobile computing device configured to communicate with the controller, the mobile computing device comprising a display configured to exhibit information; and
when generated, via the controller, sending the notification to the mobile computing device in a format adapted to be exhibited on the display.

13. The method of claim 12, further comprising:
providing a second vehicle configured to communicate with the controller;
wherein, when modified, the modification to the at least one vehicle-share record is a vehicle reassignment;
when modified, designating, via the controller, the second vehicle as the reassigned vehicle in the at least one vehicle-share record; and
wherein, when generated, the notification comprises vehicle reassignment information.

14. The method of claim 11, further comprising:
providing a mobile computing device configured to communicate with the controller, the mobile computing device comprising a GPS module configured to generate one or more GPS coordinates;
wherein the vehicle system is a GPS chipset configured to generate at least one location coordinate; and
receiving, via the controller, GPS coordinates from the mobile computing device;
receiving, via the controller, location coordinates from the vehicle; and
wherein the Return Time calculation is based, at least in part, on the GPS coordinates in relation to the at least one location coordinate.

15. The method of claim 11, further comprising:
providing a second vehicle configured to communicate with the controller;
wherein, when modified, the modification to the at least one vehicle-share record is a vehicle reassignment; and
when modified, designating, via the controller, the second vehicle as the reassigned vehicle in the at least one vehicle-share record.

16. The method of claim 11, further comprising:
wherein the memory and controller are considered a first memory and first controller;
providing a second memory configured to comprise a secondary set of executable instructions, the second memory further configured to comprise an information database; the information database comprising Consideration Data configured to be incorporated into the Return Time calculation;
providing a second controller configured to execute the secondary set of executable instructions, the second controller further configured to communicate with the first controller;
producing, via the second controller, the Consideration Data from the information database; and
sending, via the second controller, the Consideration Data to the first controller; and
wherein the Return Time calculation is based, at least in part, on the vehicle system information received from the at least one vehicle in conjunction with the Consideration Data.

17. The method of claim 16, wherein the information database is a traffic services database comprising traffic information of at least one location between the vehicle and a designated location.

18. The method of claim 16, wherein the information database is a weather services database comprising weather information of at least one location between the vehicle and a designated location.

19. The method of claim 11, wherein:
wherein the vehicle system is a GPS chipset configured to generate at least one location coordinate;
wherein the vehicle system information received from the vehicle is the at least one location coordinate;
calculate, via the controller, an Estimated Vehicle Return based on the at least one location coordinate and a designated coordinate; and
wherein the Return Time calculation is based, at least in part, on the Estimated Vehicle Return.

20. The method of claim 11, further comprising:
providing a trip analytics module configured to produce a Return Prediction;
wherein the vehicle system is a GPS chipset configured to generate at least one location coordinate;
wherein the vehicle system information received from the vehicle is one or more location coordinates;
sending, via the controller, the location coordinates to the trip analytics module; and
retrieving, via the controller, a Return Prediction produced from the trip analytics module; and
wherein the Return Time calculation is based, at least in part, on the Return Prediction.
